(19) United States
(12) Patent Application Publication
(10) Pub. No.: US 2003/0184271 A1
(43) Pub. Date: Oct. 2, 2003

(54) Eletronic circuit of low power consumption, and power consumption reducing method

(76) Inventors: Kazuo Aisaka, Kokubunji (JP); Toshiyuki Aritsuka, Kodaira (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/362,599

(22) PCT Filed: Dec. 20, 2000
(86) PCT No.: PCT/JP00/09032

(51) Int. Cl. G05F 1/40

(52) U.S. Cl. 323/283

(57) ABSTRACT

An electronic circuit of low power consumption and a power consumption reducing method are devised to attain the power consumption reduction without using the scheme of anticipation which incurs the limitation in the effect of power consumption reduction. The electronic circuit includes at least one of a power supply voltage control circuit which varies the power supply voltage in response to a voltage control signal or a clock frequency control circuit which varies the frequency of a clock signal in response to a frequency control signal, a control circuit which produces at least one of the voltage control signal or the frequency control signal, and a data processing circuit which processes an input data signal by being supplied with at least one of the power supply voltage or the clock signal. The control circuit produces the voltage control signal or the frequency control signal based on information of process amount corresponding to the input data signal and indicative of the amount of data processing executed by the data processing circuit.

### TECHNICAL FIELD

The present invention relates to a semiconductor circuit application system represented by a microcomputer, and particularly to a large-scale integrated electronic circuit used for data processing and to a power consumption reducing method for the circuit.

### BACKGROUND ART

Owing to the advanced semiconductor technology, integrated circuits are in progress in the density and scale of integration. A resulting problem of increased circuit power consumption has been coped with by the following counter measures.

A primary counter measure is to lower the frequency of a clock signal to be supplied to an integrated circuit within the allowable degree. A large-scale integrated circuit represented by a microcomputer uses a clock signal to synchronize the overall operation. The clock signal is a reference signal for the integrated circuit to time its operation, and the integrated circuit operates by transferring signals on a step-by-step basis in response to the clock signal.

Many microcomputers employ CMOS (Complementary Metal Oxide Semiconductor) integrated circuits, which are characterized by having increased or decreased power consumptions in proportion to their clock signal frequencies. Therefore, in case an integrated circuit is allowable for a low-speed operation, the clock frequency is set lower so as to reduce the power consumption.

However, a room of improvement of the above-mentioned primary counter measure has been found in recent years, and a scheme of setting a lower power supply voltage to be supplied to the integrated circuit along with the setting of a lower clock frequency is being developed as a secondary counter measure as described in the following. Generally, lowering the clock frequency relaxes the operational condition of integrated circuit, which allows the lowering of power supply voltage in many cases. This nature of integrated circuit is utilized by the secondary counter measure.

A specific scheme of the secondary counter measure is described for example in the Technique Report of IEICE (Institute of Electronics, Information and Communication Engineering), VLD 96-72 (Dec.1996). This scheme uses a DC-DC converter which can vary the power supply voltage in accordance with a reference voltage and a ring oscillator which varies the oscillation frequency in response to the power supply voltage, thereby varying the power supply voltage and clock frequency concurrently.

For practicing these two counter measures for an integrated circuit, it is necessary to know in advance the required operational speed of the circuit. In case the integrated circuit specializes in a certain purpose, the clock frequency is determined to meet the operational speed of the purpose.

Otherwise, in case the integrated circuit is oriented to extensive purposes such as the case of a microcomputer, in which the operational speed in need varies constantly, it is necessary to determine the operational speed during the operation. A specific manner of operational speed determination is disclosed for example in Japanese Patent Laid-Open No.H2-121019, as briefed in the following.

On a computer based on integrated circuits, a job management program (i.e., operating system or OS) is running, and several input jobs (programs) which operate under control of the OS are stored temporarily in a job queue within the memory, and taken out of the job queue one by one and run by the OS. The OS checks the number of jobs left in the job queue at certain time intervals. It multiplies the number to an average processing time thereby to evaluate an expectation index of the operational speed which is needed currently. Depending on the value of expectation index, the power supply voltage and clock frequency are set. Selective settings are merely among two power supply voltages and two clock frequencies according to the scheme of this patent publication.

There have been disclosed some other schemes for evaluating the above-mentioned expectation index more precisely. For example, Japanese Patent Laid-Open No.H10-187300 describes a manner of operational speed anticipation based on the quantity of input data loaded in the computer. Japanese Patent Laid-Open No.H11-353052 describes a manner of operational speed anticipation based on the assessment of the proportion of the volume of actual tasks relative to the volume of overhead tasks processed by the computer. Japanese Patent Laid-Open No.2000-20187 describes a manner of operational speed anticipation based on the kind of medium of the data file which is processed currently by the computer.

All of the above-mentioned precedent inventions are intended to perform precise power control based on the precise operational speed anticipation so that the reduction of power consumption is enhanced eventually.

### DISCLOSURE OF INVENTION

The above-mentioned anticipation schemes are all designed to evaluate the required operational speed based on the statistical computations, and therefore they inevitably involve the anticipation error to some extent. Therefore, it is necessary to set a clock frequency and power supply voltage slightly higher than the exact values in consideration of anticipation error. This setting manner precludes considerably the power consumption reduction from effectuating, as described in the following.

For a truly required operational frequency F (Hz) and operational voltage V (volts), an average consumed power Pₐ is expressed as follows.

Pₐ=kFV² (1)

where k is a proper proportional constant.

It is assumed that the control circuit which controls the clock frequency and power supply voltage sets the operational frequency to be αF in consideration of anticipation error. The α is a safety factor for the sake of a margin of operational speed, and it has avalue larger than 1. The operational voltage V also needs to be set higher in this case, which is in proportion to the operational frequency F provided that V is not too small, and accordingly it is set to be αV.

Accordingly, the consumed power Pₒ during the operation is express as follows.

Pₒ=kα³FV² (2)

Due to the marginal operational frequency by the degree of α fold, the electronic circuit completes the given task in a time of 1/α. Power is turned off in the residual time, in which conceivably there is virtually no power consumption, the average consumed power Pₜ is 1/α of the formula (2) as follows.

Pₜ=kα²FV² (3)

The Pₜ of formula (3) is 2 times the consumed power Pₐ of formula (1). Namely, the power consumption increases in proportion to the square of safety factor (as shown in FIG. 23). For example, with a 40% margin (safety factor α of 1.4) for the processing speed, the power consumption becomes 1.4 ≈ 2 times (approximately twice) the power consumption needed inherently.

For data processing with a microcomputer in general, the operational speed in need is largely dependent on the nature of data to be processed. Characteristics of video data often vary abruptly, and therefore a large safety factor must be set, e.g., a safety factor of 40% is too small in many cases. It means that the electronic circuit is designed to consume twice or more the magnitude of power that is inherently needed, and the objective of power consumption reduction cannot be attained.

With the intention of overcoming the foregoing prior art deficiency, it is an object of the present invention to provide an electronic circuit of low power consumption and a power consumption reducing method which are devised to reduce the power consumption without using the scheme of operational speed anticipation which incurs the limitation in the effect of power consumption reduction.

In order to achieve the above objective, an electronic circuit of low power consumption based on this invention is characterized by comprising at least one of a power supply voltage control circuit which varies the power supply voltage in response to a voltage control signal or a clock frequency control circuit which varies the frequency of a clock signal in response to a frequency control signal, a control circuit which produces at least one of the voltage control signal or the frequency control signal, and a data processing circuit which processes an input data signal by being supplied with at least one of the power supply voltage from the power supply voltage control circuit or the clock signal from the clock frequency control circuit, the control circuit producing the voltage control signal or the frequency control signal based on information of process amount which is correspondent to the input data signal and indicative of the amount of data processing executed by the data processing circuit.

In order to achieve the above objective, a power consumption reducing method based on this invention is characterized by comprising a step of decoding an encoded data signal, a step of evaluating the volume of processing of decoding and outputting a resulting information of process amount, a step of combining the information of process amount and the encoded data signal to produce an input data signal, a step of processing the input data signal by using the information of process amount, and at least one of a step of controlling the power supply voltage which is used for the processing of the input data signal or a step of controlling the frequency of a clock signal which is used for the processing of the input data signal.

In order to achieve the above objective, another power consumption reducing method based on this invention is characterized by comprising a step of decoding a data signal which is encoded in compliance with the MPEG (Motion Picture Coding Experts Group) standard, a step of evaluating the volume of processing of decoding and outputting a resulting information of process amount, a step of inserting the information of process amount in the extension part in the bit stream of the encoded data signal thereby to produce an input data signal, a step of processing the input data signal by using the information of process amount, and at least one of a step of controlling the power supply voltage which is used for the processing of the input data signal or a step of controlling the frequency of a clock signal which is used for the processing of the input data signal.

In any of the above-mentioned inventive circuit and methods, the information of process amount evaluated from the amount of actual data processing is used, instead of using the anticipation which calls for a safety factor, for controlling at least one of the power supply voltage or the clock signal frequency, and therefore the precise power consumption reduction can be attained. Inconsequence, it becomes possible to control the power supply voltage and clock frequency down to as low as their inherent limits, and the reduction of power consumption is effectuated more than the conventional scheme.

### BRIEF DESCRIPTION OF DRAWINGS

FIG. 1 is a block diagram used to explain the arrangement of an electronic circuit of low power consumption based on a first embodiment of this invention;

FIG. 2 is a block diagram used to explain the first embodiment which is configured by means of a microcomputer;

FIG. 3 is a diagram showing the form of input data signal;

FIG. 4 is a flowchart used to explain the operation of the control circuit;

FIG. 5 is a diagram showing the form of process amount information;

FIG. 6 is a flowchart used to explain a scheme of clock frequency determination;

FIG. 7 is a diagram used to explain an example of the structure of an F-V correspondence table;

FIG. 8 is a diagram showing the form of a bit stream of the short header mode in the MPEG standard;

FIG. 9 is a diagram used to explain the form of a bit stream resulting from the insertion of the process amount information into the bit stream shown in FIG. 8;

FIG. 10 is a diagram showing the form of process amount information based on a second embodiment of this invention;

FIG. 11 is a set of diagrams used to explain specific examples of process patterns in picture decoding;

FIG. 12 is a diagram used to explain an example of the structure of a clock frequency table for individual patterns;

FIG. 13 is a flowchart used to explain a scheme of clock frequency determination based on the second embodiment;

FIG. 14 is a diagram showing an example of the structure of a process amount information table;

FIG. 15 is a flowchart used to explain a power consumption reducing method based on a third embodiment of this invention;

FIG. 16 is a diagram used to explain the organization of a process amount information providing service system and associated communication protocol based on the third embodiment;

FIG. 17 is a diagram showing an example of the structure of a process amount information table used in the process amount information providing service system;

FIG. 18 is a block diagram used to explain the arrangement of a data signal generator for practicing the power consumption reducing method based on a fourth embodiment of this invention;

FIG. 19 is a flowchart used to explain the operation of the decoding process simulation circuit;

FIG. 20 is a diagram showing an example of the structure of environment information tables;

FIG. 21 is a block diagram used to explain the arrangement of a data signal relay for practicing the power consumption reducing method based on a fifth embodiment of this invention;

FIG. 22 is a block diagram used to explain the arrangement of a data processor for practicing the power consumption reducing method based on a sixth embodiment of this invention; and

FIG. 23 is a graph used to explain the relation between the safety factor α and the consumed power P.

### BEST MODE FOR CARRYING OUT THE INVENTION

Preferred embodiments of the inventive electronic circuit of low power consumption and the inventive power consumption reducing method will be explained in detail with reference to the drawings. Same or like items are referred to by the common symbols throughout the drawings.

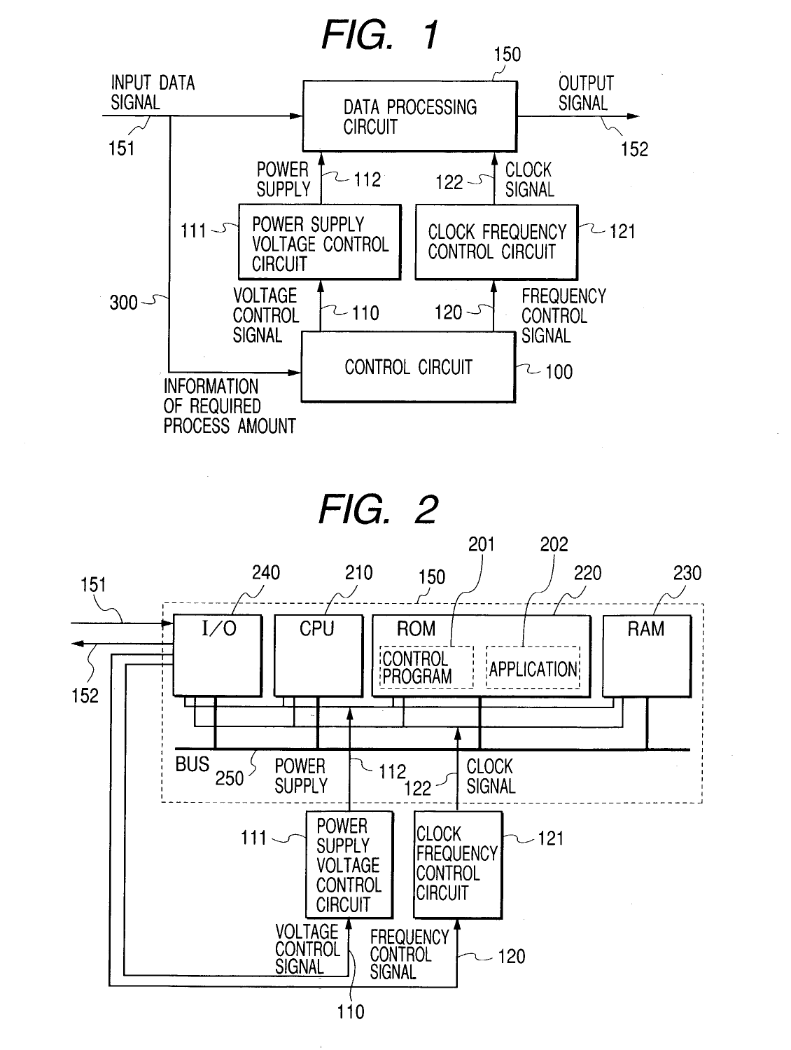

FIG. 1 shows the overall arrangement of an electronic circuit of low power consumption based on the first embodiment. The electronic circuit includes a data processing circuit 150, with the power consumption thereof being controlled based on this invention, a power supply supply voltage control circuit 111 which controls a power supply voltage 112 to be supplied to the circuit 150, a clock frequency control circuit 121 which controls the frequency of a clock signal 122 to be supplied to the circuit 150, and a control circuit 100 which produces a voltage control signal 110 to the power supply voltage control circuit 111 and a frequency control signal 120 to the clock frequency control circuit 121.

Based on the two kinds of control including power supply voltage control and clock frequency control, the power consumption is reduced. An input data signal 151 is supplied by broadcasting or over a transmission line of a network, or it is supplied by means of an electronic recording medium such as DVD (Digital Versatile Disc).

The data processing circuit 150 is a circuit having functions of processing a certain input data signal 151 which is put in to it, and outputting a certain output signal 152. The present invention is applicable regardless of the functions of the data processing circuit 150 and the forms of the input data signal 151 and output signal 152. Specifically, for the expedience of explanation of the following embodiments, the data processing circuit 150 is a video decoder, the input data signal 151 is a picture stream encoded in compliance with the international MPEG standard, and the output signal 152 is a video signal resulting from the decoding of the stream. The present invention is not confined to this example of practice obviously, but the input data signal may be an audio data signal instead, for example.

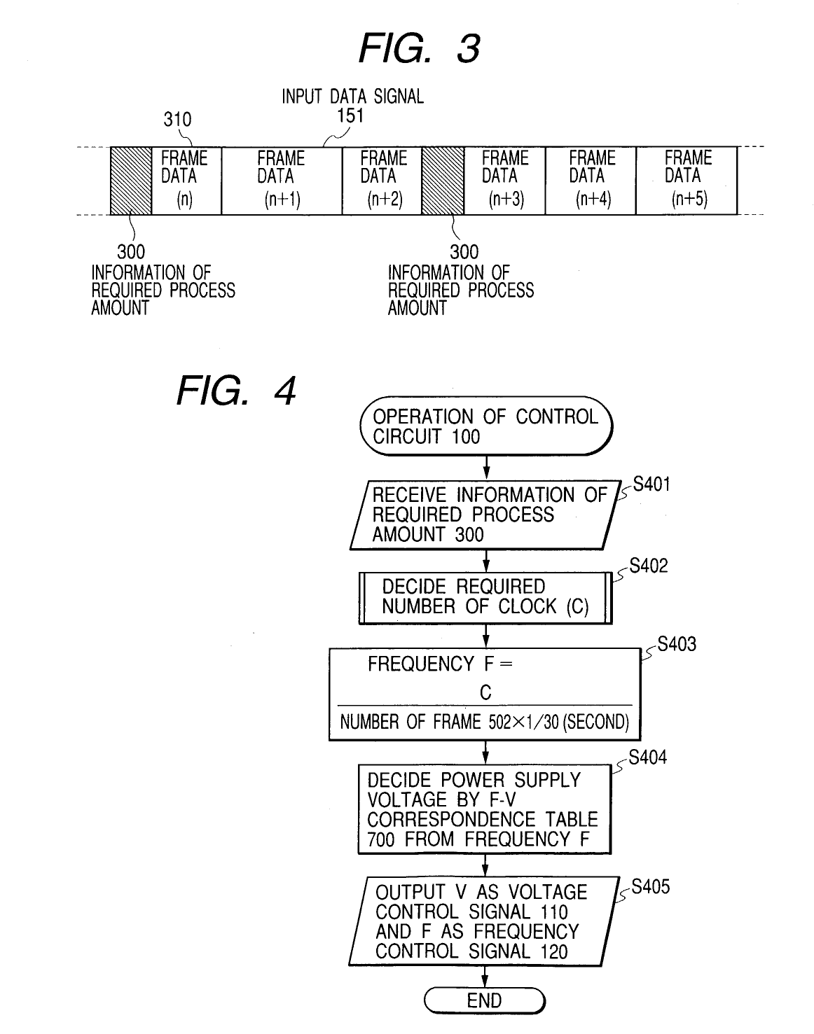

The present invention is characterized by using process amount information 300 which is put in to the control circuit 100. The content of the process amount information 300 and a specific circuit operation based on the use of the information 300 will be explained in detail with reference to FIG. 3 and following drawings.

The control circuit 100 can be designed in various fashions, e.g., it can be made up entirely of hardware components. Actually, however, the control circuit 100 which determines the voltage control signal 110 and frequency control signal 120 based on the intricate computations is realized more conveniently in the form of programs which run on a computer. In this case, a computer is included in the data processing circuit 150, and the computer controls other hardware components on a software basis. This software-based arrangement will be explained with reference to FIG. 2.

In FIG. 2, the data processing circuit 150 which is the subject of power reduction control is a microcomputer, in which a CPU 210, a ROM 220, a RAM 230 and an I/O 240 are linked through a bus 250. The ROM 220 stores a control program 201, and the CPU 210 executes commands of the program 201 to perform the control circuit 100. The ROM 220 further stores application programs 202 in addition to the control program 201, by which various functions, e.g., picture decoding, are executed by use of the microcomputer.

The voltage control signal 110 and frequency control signal 120 are parts of outputs from the I/O 240, and these signals are put in to the power supply voltage control circuit 111 and clock frequency control circuit 121 outside the microcomputer. The input data signal 151 and output signal 152 are transacted with the outside through the I/O 240. The ROM 220, RAM 230 and I/O 240 may be formed on a common semiconductor circuit chip together with the CPU 210, or otherwise may be built as separate parts. Similarly, the power supply voltage control circuit 111 and clock frequency control circuit 121 may be formed together on the semiconductor circuit chip of the CPU 210.

The power supply voltage control circuit 111 is realized, for example, as a DC-DC converter which varies the output voltage in accordance with the reference voltage carried by the voltage control signal 110. The clock frequency control circuit 121 is realized, for example, as a frequency synthesizer based on PLL (Phase-Locked Loop), which varies the output frequency in response to the frequency control signal 120.

Next, the input data signal 151 will be explained in detail with reference to FIG. 3. The input data signal 151 shown in FIG. 3 is a picture stream resulting from MPEG-based encoding, i.e., time-sequenced signal (bit stream), as mentioned previously, and it consists of consecutive frame data 310 each representing a frame of encoded picture, with process amount information 300 being inserted at certain intervals of frame data (three frames in this example).

The picture stream is formed at the time of generation of the input data signal 151, as will be explained in detail later.

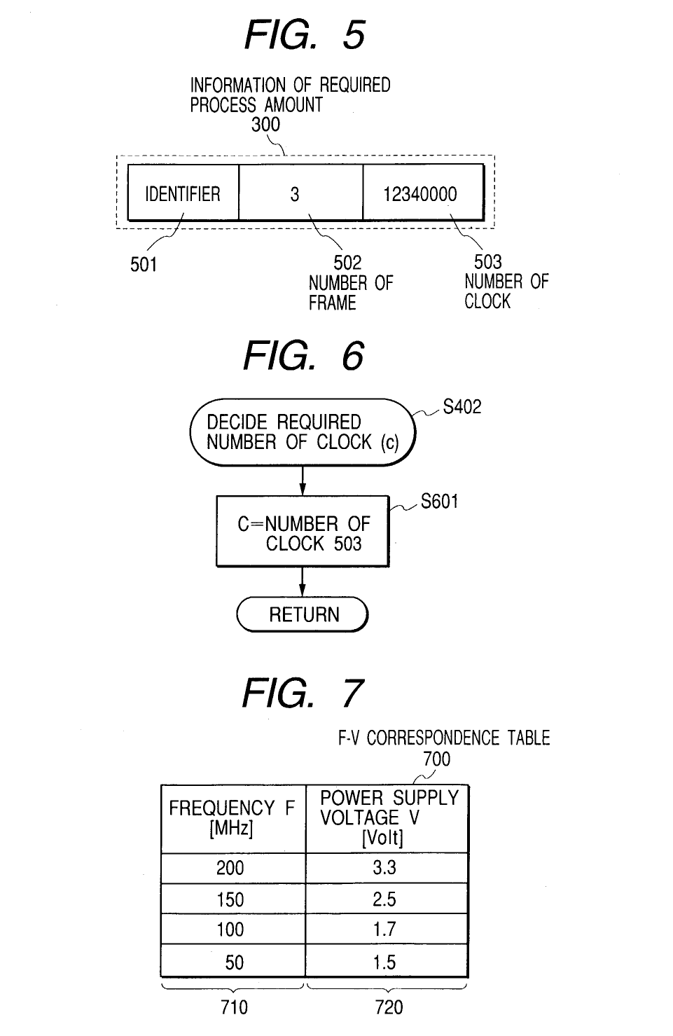

The process amount information 300 is a series of data 501,502 and 503 indicative of the identifier, the number of frames and the number of clocks, respectively, as shown in FIG. 5. The identifier 501 is a code which distinguishes the process amount information from the frame data, and has its format determined in compliance with the coding rule of frame data. The number of frames data 502 indicates the information of process amount in terms of the number of frames (three frames in this example) to which the number of clocks 503 given next to it corresonds. The number of clocks 503 indicates the number of clocks which is needed by the CPU 210 to process the objective frame data.

The process amount information indicates precisely the volume of processing (decoding in this example) of each unit of processing (three frames in this embodiment) executed by the data processing circuit 150. Using the precise required process amount included in the input data signal, instead of relying on the anticipation that is the case of the conventional manner, is the feature of this invention.

By using the above-mentioned information, at each incoming of process amount information 300, the control circuit 100 executes actions as shown by the flowchart of FIG. 4. Initially, the control circuit 100 receives a piece of process amount information 300:(step 401, hereinafter s401 for short), and it determines a necessary number of clocks C from the information:(s402). From the value of C, it calculates a frequency F as follows (s403).

Frequency F=C/(number of frames 502×1/30(sec))

The control circuit 100 determines a power supply voltage V from the value of F by referencing a F-V correspondence table 700 shown in FIG. 7:(s404). It outputs resulting values of F and V as the voltage control signal 110 and frequency control signal 120, respectively:(s405), and completes a control operation cycle.

The foregoing s402 is a subroutine for determining the value of C, and it is shown in detail by the flowchart of FIG. 6. Specifically, in s601 sets the number of clocks 503 to the value of C is set. Since the required value of C is noted directly in the process amount information 300, the s402 can be extremely simple. Another example of the determination of C based on a more intricate computation will be described later in the second embodiment.

FIG. 7 shows the F-V correspondence table 700 used in the s404. The table contains a list of values 710 of frequency F and corresponding values 720 of power supply voltage V. In referencing the table, if a value of F calculated in the step 403 is absent among the values 710, a listed value that is closest to the calculated F on its increment side is fetched.

According to this embodiment, it is possible to carry out the power consumption reduction precisely based on the simple program without the use of a safety factor.

An example of the input data signal 151 in the form of a picture stream based on the international MPEG standard will be explained in the following.

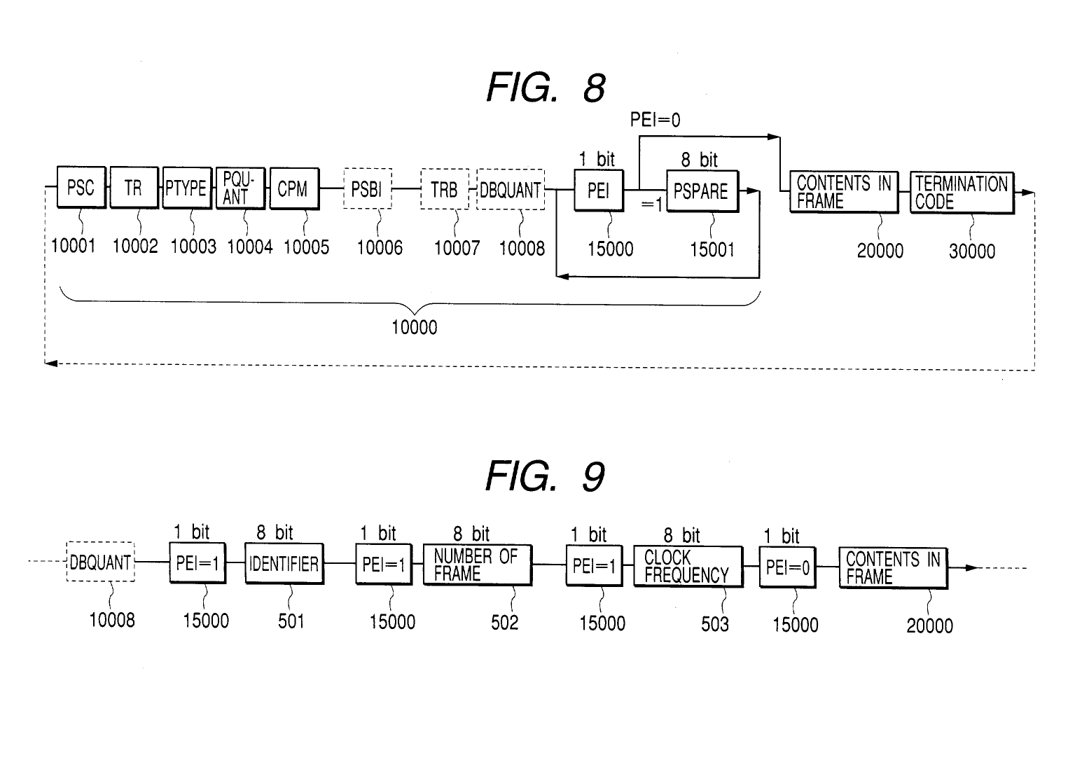

Among the various modes arranged in the MPEG standard, the input data signal 151 of this embodiment is conformable to the simple profile and short header mode. In the short header mode, a picture is transmitted in the form of a frame in a bit stream as shown in FIG. 8. Each frame consists of a header section 10000 indicative of the attribute of frame, a content section 20000 of the encoded frame content, and a termination code 30000 indicative of the end of frame. These sections of frame are transmitted sequentially in this order, which are followed by successive frames cyclically.

The frame content 20000 includes compressed information resulting from discrete cosine transformation (DCT) for the frame and motion vector information which indicates the movement of picture from the previous frame. More detailed description of them is omitted. The termination code 30000 is a code having a special form for indicating the end of frame. More detailed explanation of it is omitted.

The header section 10000 is arranged to transmit sequentially various pieces of information 10001-10005 indicative of the attribute of the frame, as stated in the standard. It includes a start code PSC10001, display timing data (temporal reference) TR10002, picture size, etc. PTYPE10003, quantization coefficient 10004, and PCM mode flag 10005. Other pieces of information 10006-10008 (more detailed explanation is omitted) may be added depending on the contents of information 10001-10005.

In the short header mode, these pieces of information are followed by a flag PEI15000 indicative of the presence of an extension part and the extension part itself PSPARE15001. The flag PEI15000 is a piece of 1-bit data. The extension part PSPARE15001 is absent when the flag value is “0”, in which case the flag is immediately followed by the frame content 20000. Otherwise, a flag value of “1” indicates that the extension part PSPARE15001 follows immediately.

The extension part PSPARE15001 is a fixed length information of 8-bit data, with its content being left undefined at present for the sake of expansion of standard in the future. It is determined that another flag PEI15000 can be placed subsequently, when the extension part PSPSRE15001 is transmitted. Accordingly, information of arbitrary sizes can be transmitted by being contained in extension parts PSPARE15001 in cyclic combinations of the code of PEI=“1”+PSPARE.

FIG. 9 shows an example of the arrangement of bit stream for the transmission of process amount information 300 by use of the extension part PSPARE15001. In this example where the process amount information 300 of the form shown in FIG. 5 is transmitted, conventional additional attribute information (DBQUANT10008, ect.) is followed by PEI=1, and next the identifier 501 is transmitted by being contained in the following PSPARE section. Another PEI=1 is transmitted, and the number of frames 502 is transmitted in the following PSPARE section. The third PEI=1 is transmitted, and the number of clocks data 503 is transmitted in the following PSPARE section. After the above-mentioned transmission, PEI=0 is transmitted to complete the extension parts, the operation proceeds to the transmission of the frame content 20000.

It is necessary to transmit the number of frames data 502 and number of clocks data 503 in 8-bit length each so as to be consistent with the form of extension part PSPARE15001. For this, blank bit positions are filled with 0 and excessive lower bits are truncated. The value of identifier 501 is defined appropriately as part of the MPEG coding rule.

In this manner, the input data signal 151 which complies with the MPEG standard is produced.

It should be noted that the present invention which is characterized by using the process amount information is also applicable to the case where only one of the power supply voltage or clock frequency is controlled. A data processing circuit designed to operate at a lower power supply voltage does not tolerate a large variation of voltage, in which case only the clock frequency is controlled. A data processing circuit formed of bipolar transistors for example does not vary in power consumption in response to the variation of clock frequency, in which case only the power supply voltage is controlled. Even in these cases of single-item control, using the process amount information can attain the greater reduction of power consumption as compared with the conventional scheme.

In this embodiment, the number of clocks 503 is placed in the process amount information 300 as mentioned previously. The number of clocks is applicable differently depending on the type of CPU, and therefore the foregoing embodiment is oriented to each specific CPU. The compatibility of clocks is expanded to cover different types of CPU, as will be explained as a second embodiment in the following.

The arrangements shown in FIG. 2, FIG. 3 and FIG. 4 of the first embodiment are common to the second embodiment. In the second embodiment, however, the control program 201 of FIG. 2 runs much faster based on the alteration of the subroutine of step 402 shown in FIG. 4. This change is accompanied by the alteration of the process amount information 300. It is explained by using several drawings.

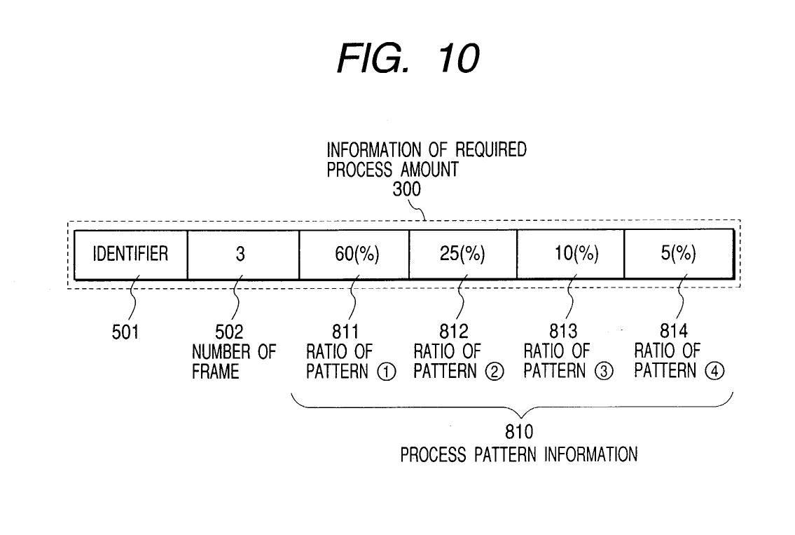

First, a new form of process amount information 300 will be explained with reference to FIG. 10. The process amount information 300 of this embodiment consists of an identifier 501, number of frames 502, and process pattern information 810. The identifier 501 and number of frames 502 are the same as shown in FIG. 5. The process pattern information 810 is a string of proportion data 811 of pattern \hat{1}, proportion data 812 of pattern \hat{2}, and so on.

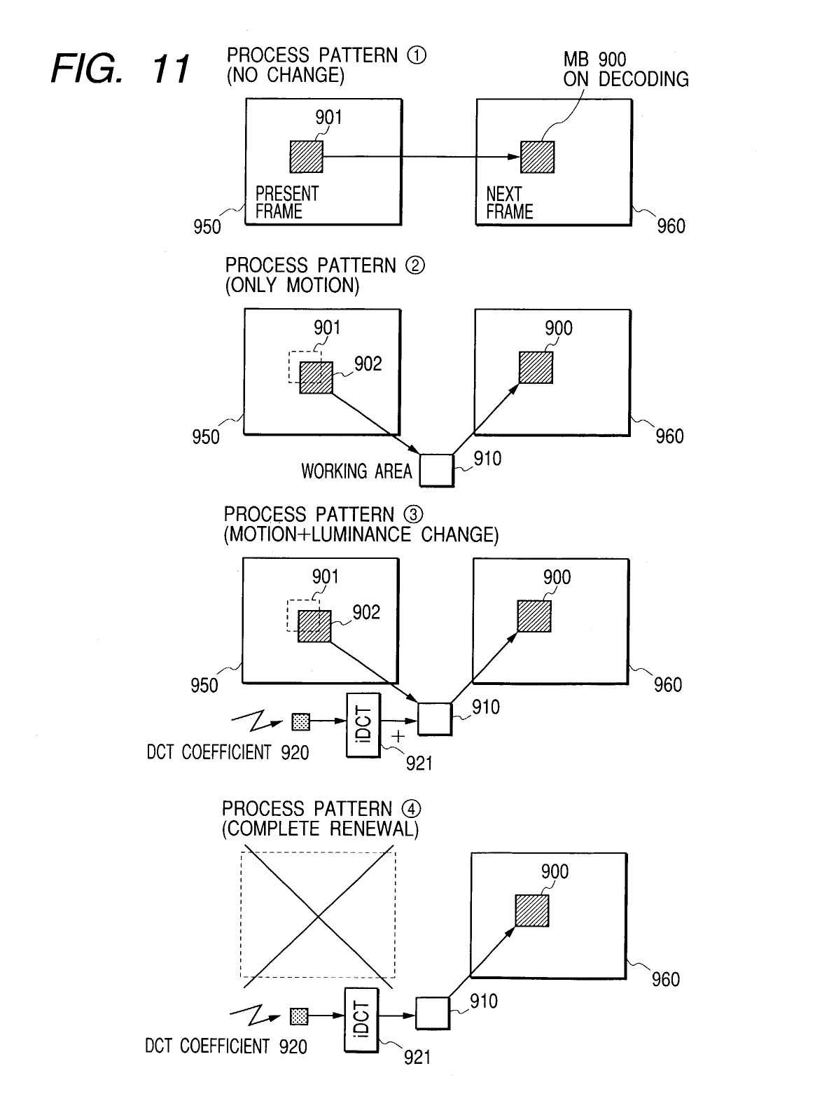

Process patterns are types of data processing procedures instructed to the program. Specific examples of process patterns will be explained with reference to FIG. 11, which shows the classified patterns of picture decoding process based on the simple profile mode of the MPEG4 standard. The decoding process uses the current frame (a frame which has been decoded immediately) 950 as a source frame used to produce the next frame 960. The processing takes place by dividing the frame into small areas of 16-by-16 pixels called macro-blocks (hereinafter MB for short) and treating each MB sequentially.

A macro-block 900 of the next frame 960 is made in a manner out of the manners represented by four major process patterns as follows.

Pattern \hat{1}: The image of MB 900 is completely unchanged from the previous frame. The image of MB 901 of previous frame at the same position as MB 900 is copied to make the image of MB 900.

Pattern \hat{2}: There is a motion in picture in the portion of MB 900. The image in a portion 902 which is slightly away from MB 901 is copied. The copy process takes place by way of a working area 910 in order to correct the positional shift.

Pattern \hat{3}: There is a motion and variation of brightness in picture in the portion of MB 900. The image of the portion 902 is copied to the working area 910, and the image of area 910 is modified to adjust the brightness. The value of modification, which is given in the form of discrete cosine transformation (DCT) coefficient 920, is rendered the inverse transformation (iDCT) for conducting the modifying process.

Pattern \hat{4}: The image of MB 900 is completely renewed. The image of MB 900 is made based solely on a DCT coefficient 920, while neglecting data of the MB 901.

The number of processing clocks needed by the CPU differs significantly among these four pattern types, while it does not much vary when a same process pattern continues. Accordingly, by evaluating a frequency information which indicates the frequency of occurrence of each pattern, the required process amount can be known virtually. This frequency information does not depend on the type of CPU, and therefore it is generally useful.

The process amount information shown in FIG. 10 is transmitted as the frequencies of occurrence of the process patterns described above. The number of process patterns to be prepared, which is four in this example, is determined to meet individual applications.

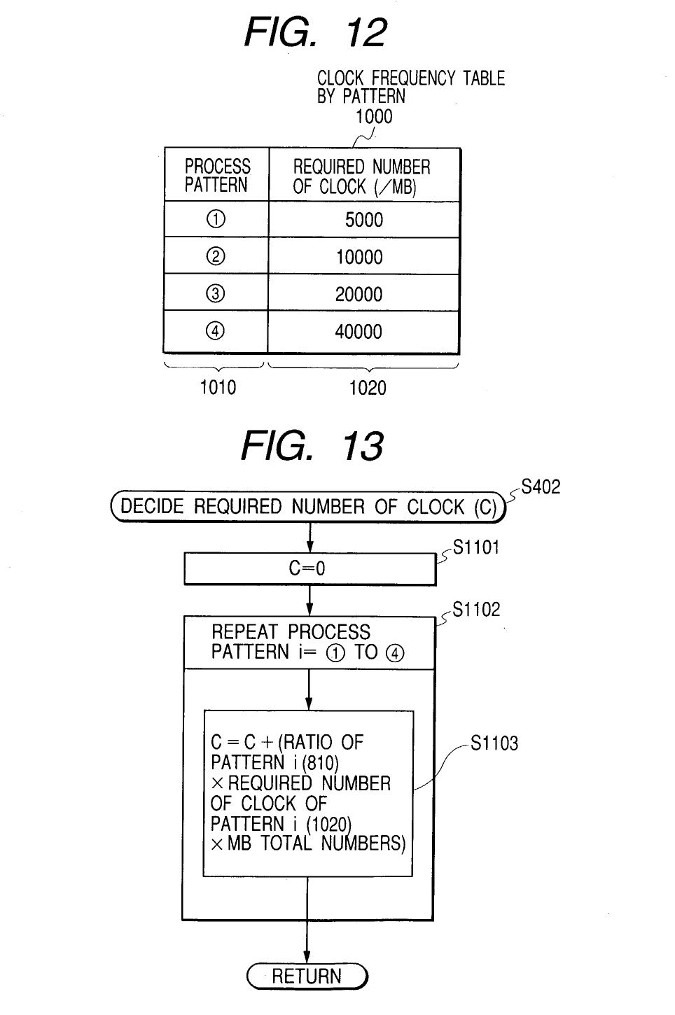

At the s402 of the operation of the control circuit 100, required number of clocks in this embodiment, that is, the value of the total number of clocks C is determined by use of the process amount information 300 as shown by the flowchart of FIG. 13. Initially, the required number of clocks C is cleared (s1101), and the calculation of C is repeated cumulatively for the four kinds of patterns (process pattern number i ranging from \hat{1} to \hat{4} (s1102). The cumulative calculation takes place for each pattern as follows. The total number of macro-blocks, i.e., the total number of occurrences of all patterns, is multiplied to the frequency of occurrences, i.e., the proportion of occurrence 810 (P[i]), of the immediate pattern, and a resulting total number of macro-blocks treated by this pattern is further multiplied to the number of clocks 1020 (K[i]) for the pattern read out of the number of clocks table 1000 shown in FIG. 12 (s1103)

The calculation of C is formulated as follows.

C=C+(ratio of pattern i (810)×(required number of clocks of pattern i (1020)×total number of macro-blocks).

The number of clocks table 1000 shown in FIG. 12 is a list of process patterns 1010 and corresponding data 1020 of the number of processing clocks expended for each macro-block by the CPU 210.

The pattern number i is incremented from \hat{1} to the total number of patterns, which is four in this example, during the above calculation.

In place of the process pattern information 810, the complexity estimation header information for video stated in the MPEG4 standard may be used.

The table of FIG. 12 can be set up by the CPU itself of each type, and this embodiment, which uses the form of frequency information shown in FIG. 10, can build a generalized system which does not depend on the type of CPU.

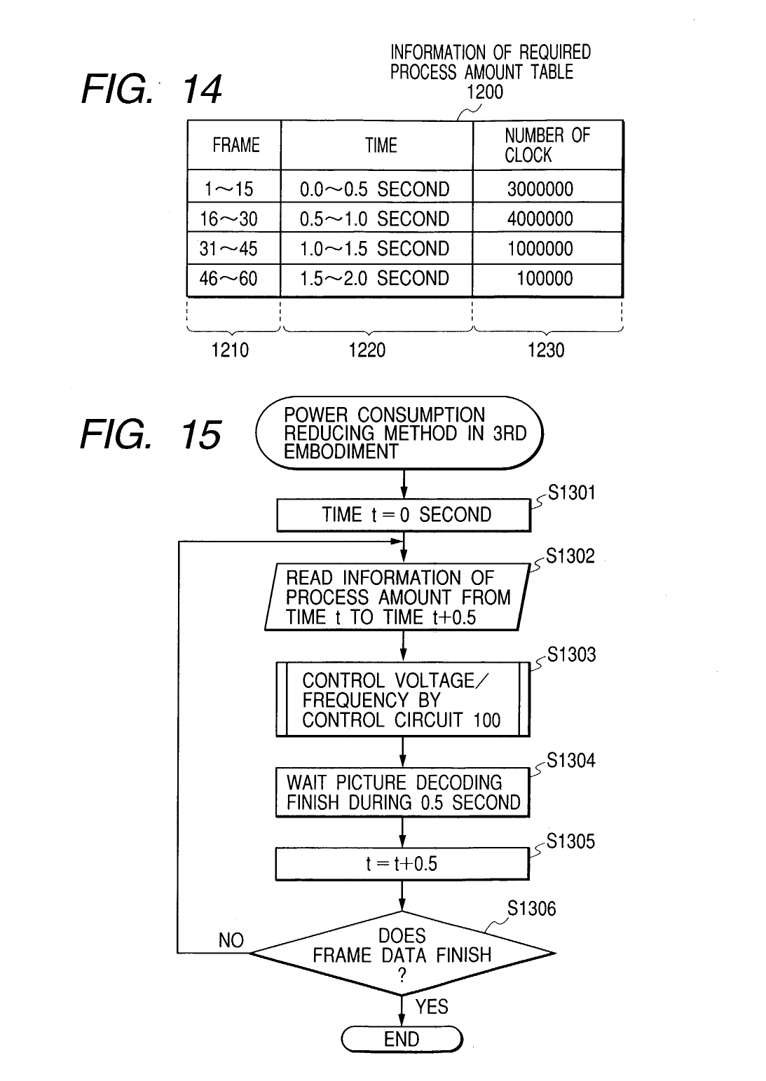

In contrast to the foregoing first and second embodiments, in which the process amount information 300 is sent by being inserted at certain positions of the input data signal 151, an alternative conceivable manner is to deal with the process amount information 300 and the frame data 310 separately as will be explained as a third embodiment in FIG. 14.

FIG. 14 shows a table of process amount information 1200 which substitutes the process amount information 300 used in the preceding embodiments. The table has a frame number field 1210, time field 1220 and the number of clocks field 1230. The frame number field 1210 indicates a frame number which corresponds to frame data. The time field 1220 indicates the range of playback time in correspondence to the frame number. The number of clocks field 1230 indicates the number of processing clocks needed by the CPU 210 in correspondence to the playback time range. In case frames are displayed at constant time intervals, one of the frame number field 1210 or time field 1220 may be omitted.

For the reduction of power consumption based on the use of the process amount information 1200 in this embodiment, the CPU 210 must fetch by itself the value of the volume of processing needed. Specifically, the CPU 210 operates on the control circuit 100 in accordance with the procedure shown by the flowchart of FIG. 15.

First, time t is initialized to 0 (s1301), and next the number of clocks C (process amount information) for the time is read out of the number of clocks field 1230 (s1302). The control circuit 100 executes the power supply voltage control and clock frequency control based on the value of C (s1303). This control operation is identical to that shown in FIG. 4, and further explanation is omitted.

The operation halts for 0.5 sec until picture decoding ends (s1304), and the time t is advanced by 0.5 sec (s1305). The operation terminates if the frame data finishes at this time point, or otherwise the sequence returns to the s1302 to repeat similar operations (s1306).

The process amount information table 1200 includes the number of clocks field 1230 as explained above, or otherwise a list of the frequencies of occurrence of the process patterns may be registered as in the case of the second embodiment.

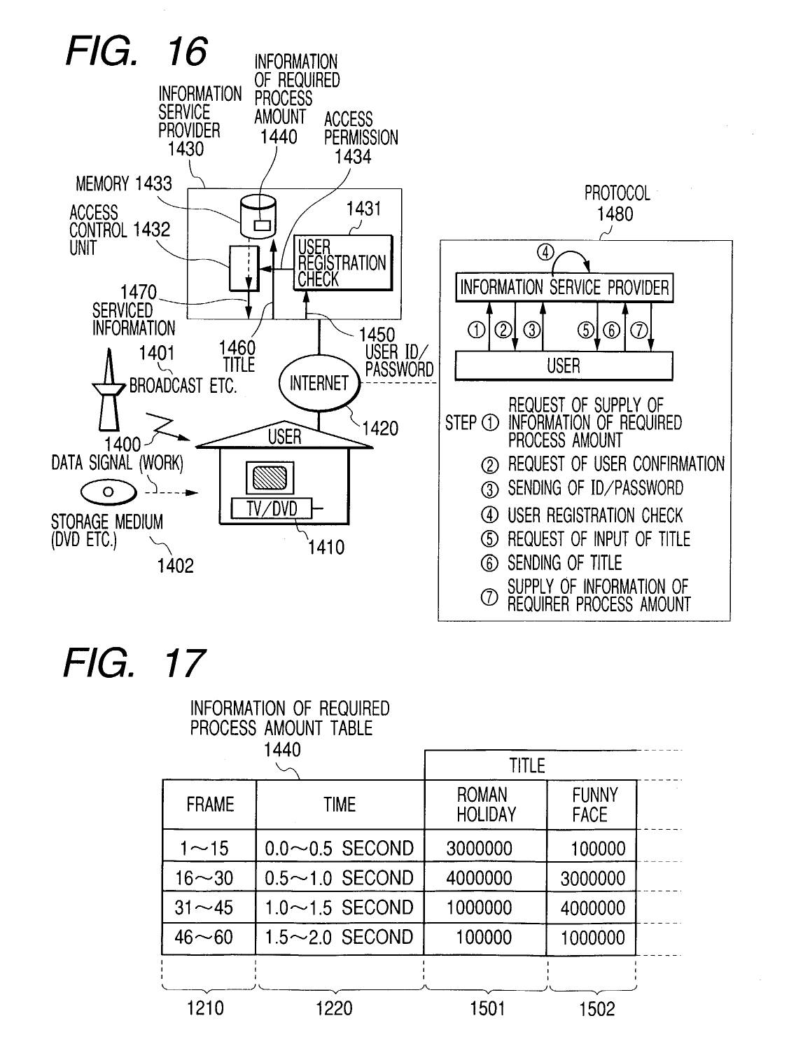

This embodiment enables the accumulation and transmission of the process amount information table 1200 independently of the frame data. This property can be used to organize a service system for providing the process amount information as will be explained with reference to FIG. 16.

In the service system, data signals 1400 are circulated through transmission means 1401 such as broadcasting and by means of electronic storage mediums 1402, and the content of signal is reproduced by an audio/video (A/V) unit 1410 such as a TV unit or DVD unit in the user's home. It is assumed that the data signals 1400 are different from the data signal 151 of the foregoing embodiments and do not include the process amount information 300, meaning that the present invention cannot be used immediately. It is also assumed that the data signals 1400 carry fixed contents of motion pictures and the like which can be identified individually based on their titles.

The data signal delivery service takes place as follows. The user's A/V unit 1410 is linked through a bidirectional communication means 1420 such as the Internet to an information service provider 1430. The information service provider 1430 has a user registration check unit 1431, access control unit 1432 and information memory 1433, and it delivers the process amount information to the user in accordance with a communication protocol 1480.

Specifically, the user sends a request of delivery of the process amount information (step 1), and the provider responds to this request to issue a request of user conformation (step 2). The user sends the user ID and password 1450 which prove the user legitimacy (step 3). The user registration check unit 1431 confirms the legitimacy of user and issues an access permission 1434 for the user to the access control unit 1432 (step 4). The provider prompts the user to enter a desired title of content (step 5).

The user sends a title of content 1460 (step 6). The access controller 1432 searches the information memory 1433 for process amount information relevant to the content, and sends the serviced information 1470 to the user (step 7).

The information memory 1433 stores a process amount information table 1440 for many contents in the form as shown in FIG. 17 for example. The table has a frame number field 1210 and time field 1220, which are similar to those of the process amount information table 1200, and number of clocks fields 1501,1502, and so on for individual contents. The information service provider selects a field which corresponds to the specified title of content 1460 from among the fields 1501,1502, and so on, and combines it with the frame number field 1210 and time field 1220 thereby to arrange the serviced information 1470. In case the user legitimacy check fails, the provider suspends the communication with the user.

This information service system enables the use of the power consumption reduction scheme of this invention even in case the data signals 1400 do not include the process amount information 300, and the reduction of power consumption of user units is effectuated.

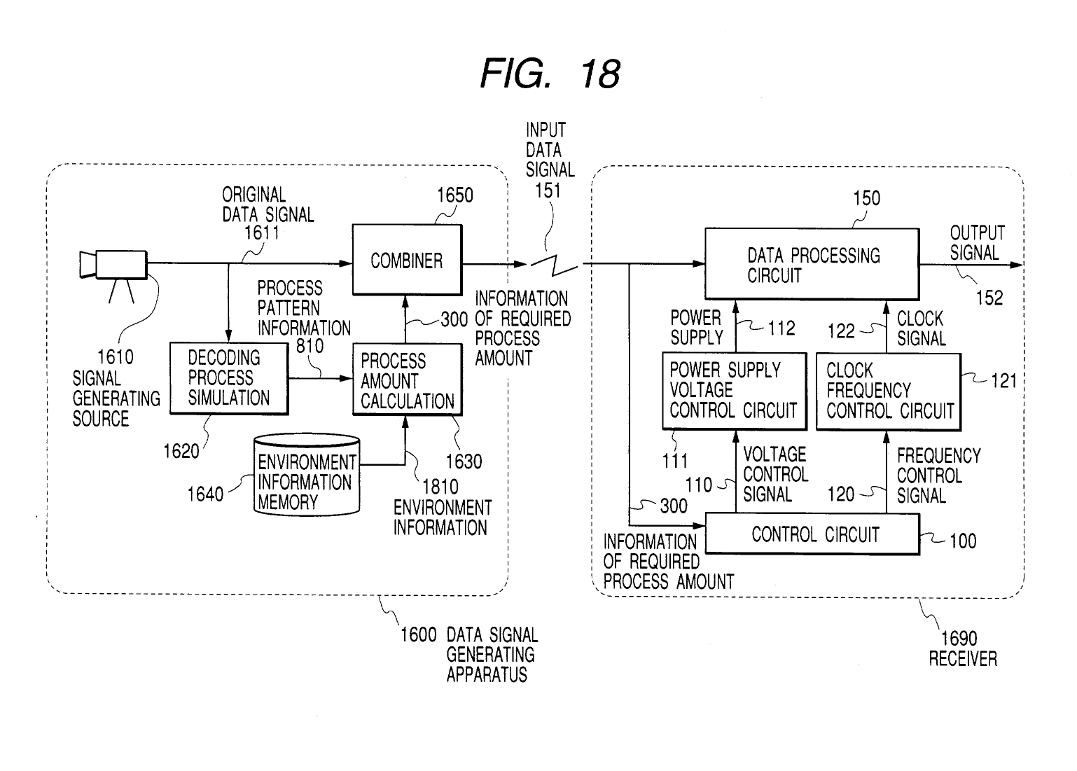

In regard to the process amount information 300 used in the foregoing first, second and third embodiments, a specific manner of its arrangement will be explained with reference to FIG. 18 and following figures.

FIG. 18 shows a fourth embodiment of this invention which is a data signal generating apparatus 1600 used for practicing the inventive power consumption reducing method. The data signal generating apparatus 1600, which produces the process amount information 300, includes a signal generating source 1610 such as a video camera, a decoding process simulation unit 1620 which decodes an original data signal 1611 from the signal generating source 1610, a process amount calculation unit 1630 which calculates the volume of decoding process and outputs the process amount information 300, an environment information memory 1640 which stores data of the types of electronic circuits, i.e., receiver 1690, and a combiner 1650 which adds the process amount information 300 to the original data signal 1611.

The signal generating source 1610 puts out the original data signal 1611 in the MPEG signal form or the like. The original data signal 1611 is put in to the decoding process simulation unit 1620 and combiner 1650. The signal generating source 1610, such as a video camera, is commercially available, and the explanation is omitted.

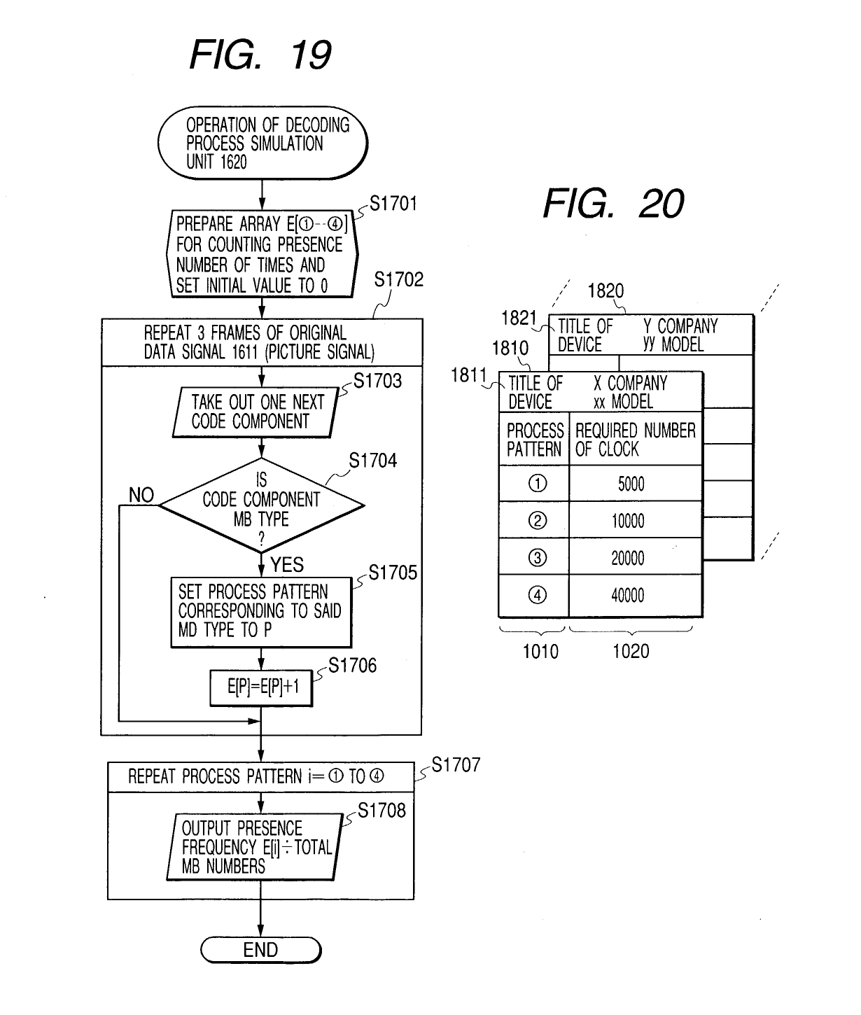

The decoding process simulation unit 1620 having an input of the original data signal 1611 operates as shown by the flowchart of FIG. 19 to produce the process pattern information 810 which has been explained in the second embodiment.

At the beginning, arrays E [i] (i=\hat{1} to \hat{4}) which are prepared for counting the numbers of occurrences of the four process patterns are initialized to contain 0 (s1701). Next, for three frames of the original data signal 1611 (picture stream in this example), the following steps 1703 through 1706 are repeated (s1702).

Initially, one code element is taken out of the picture stream (s1703). The code element is checked as to whether it is the element of specifying the type of macro-block, and if the check fails (no), the following steps 1705 and 1706 are skipped (s1704). Otherwise, if the check passes (yes), the sequence proceeds to the next step to find one (P) of the process patterns \hat{1} to \hat{4} to be used for the process of the macro-block (s1705).

Finally, element E[P] of array E corresponding to the process pattern P is incremented by one. As a result of repetition of the above operations, the numbers of occurrences of all process patterns are counted in the arrays E, and these values are converted into the frequencies of occurrence and outputted in the following steps. Specifically, the operation of dividing the frequency of occurrence E[i] (i=\hat{1} to \hat{4}) by the total number of macro-blocks and outputting (s1708) a resulting value is repeated for the process patterns i (i=\hat{1} to \hat{4}) (s1707).

The resulting process pattern information 810 can be used for the process amount information 300 of the form shown in FIG. 10 for example. In consequence, the input data signal 151 which has been explained in the second embodiment is obtained. The process amount calculation unit 1630 is practically unused in this case.

As an alternative manner, the process pattern information 810 can be converted into the process amount information 300 of the form shown in FIG. 5. In this case, the process pattern information 810 is put in to the process amount calculation unit 1630 so that it is converted into the number of clocks 503. For this conversion process, the scheme of determining the required number of clocks (C) shown in FIG. 13 can be used. The condition of operation (CPU type, etc.) of the receiver 1690 must be known in advance for the provision of the table 1000 (shown in FIG. 12) needed for the calculation. For this purpose, the environment information memory 1640 which stores operational conditions of various kinds of receivers are provided.

The environment information memory 1640 stores tables of many pieces of environment information as shown in FIG. 20. The environment information 1810, 1820, and so on, includes a record of the numbers of processing clocks 1020 in correspondence to the process patterns 1010 in the same fashion as FIG. 12. Further included is an applicable environment field 1811 (1821, and so on), which contains the condition of use of the environment information, e.g., the condition of use is based on the manufacturer's name and model number of the receiver 1690 as shown. Alternatively, this field may be used to write the type of CPU or type of OS. The process amount calculation unit 1630 gets the rating of the receiver 1690 in some way, and thereafter selects an environment information 1810 (1820, and so on) that meets the rating and uses it for the calculation of the number of clocks.

The combiner 1650 combines the process amount information 300 and original data signal 1611 which are obtained in the foregoing manner, thereby producing the input data signal 151. For example, in the case of producing a bit stream based on the simple profile and short header mode of the MPEG standard shown in FIG. 9, the transmission of the identifier 501, number of frames data 502 and number of clocks data 503 by use of the extension part PSPARE15001, i.e., the insertion of these data in the extension part PSPARE15001 becomes the combining operation by the combiner 1650.

The input data signal 151 put out from the combiner 1650 is transmitted to the receiver 1690. The operation of the receiver 1690, i.e., electronic circuit of low power consumption, which gives a performance by receiving the input data signal 151 is the same as explained in connection with FIG. 1 and other figures.

The arrangement of the decoding process simulation unit 1620 is not confined to the foregoing, but an alternative design is to use another receiver which is the same as the receiver 1690 and adapted to measure the number of operation clocks of the receiver.

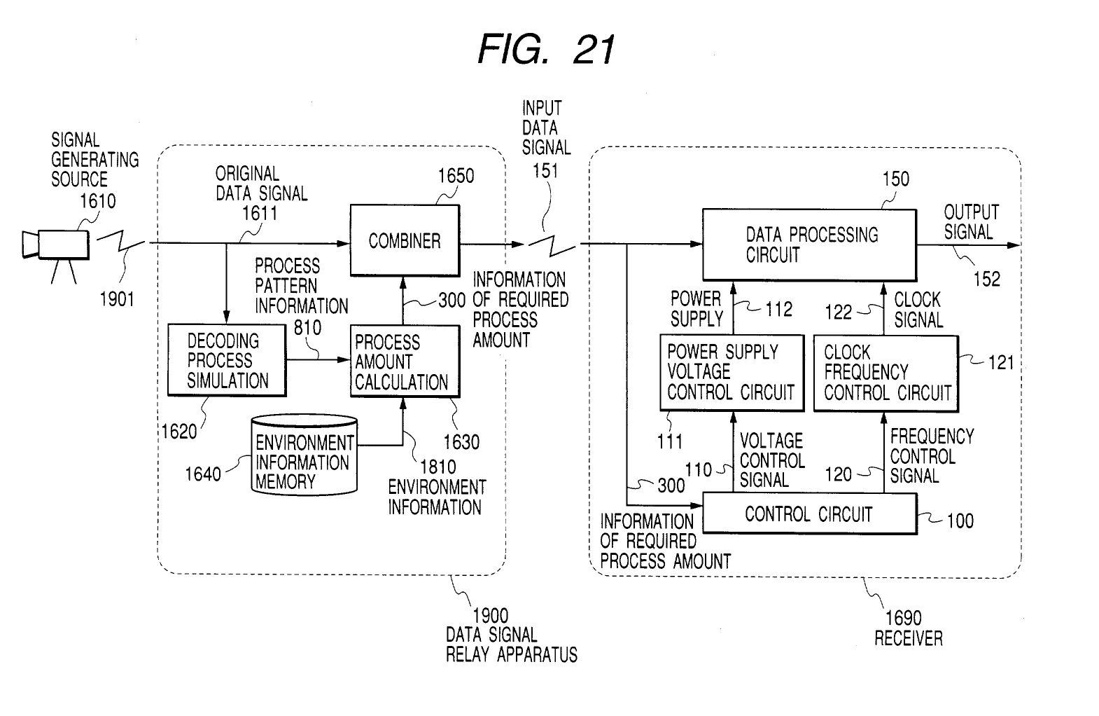

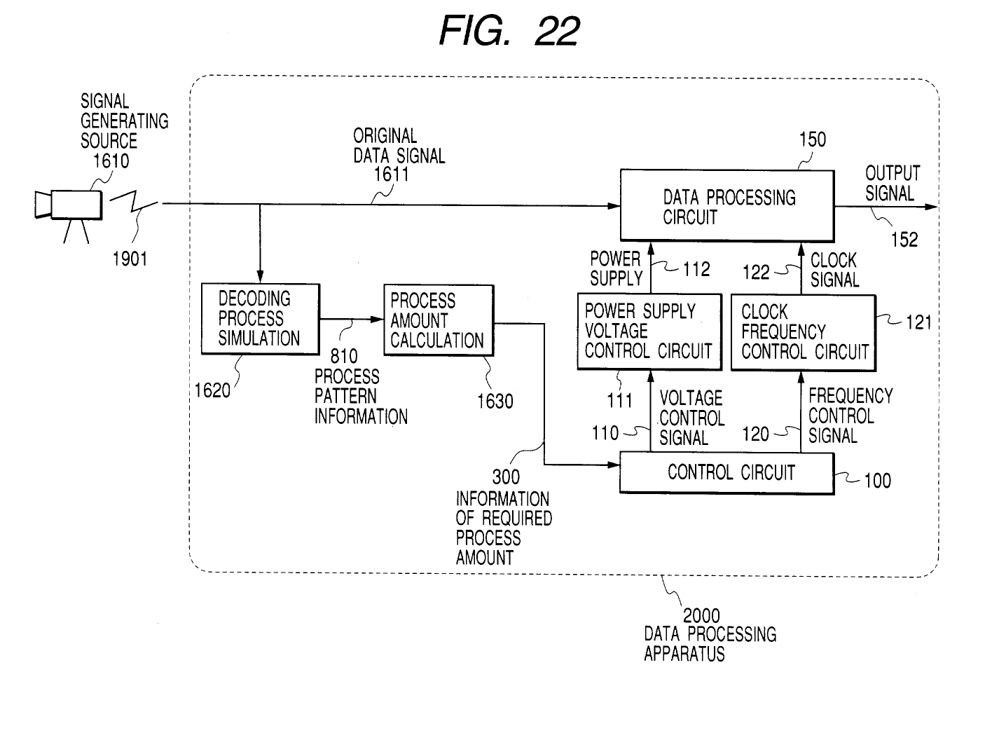

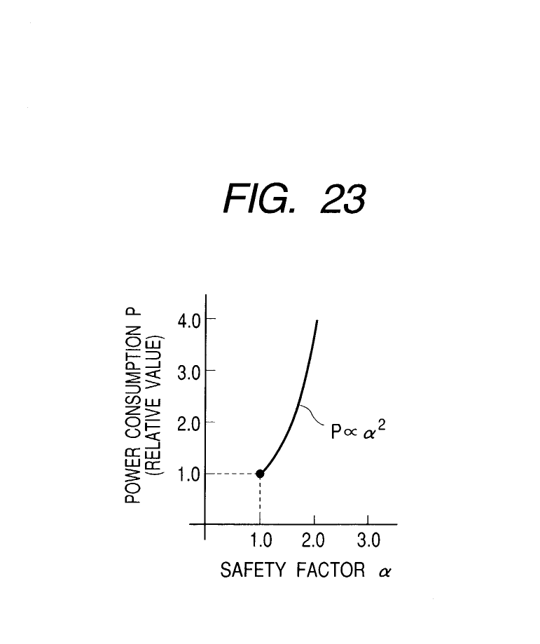

FIG. 21 shows a fifth embodiment of this invention which is designed to insert the process amount information 300 by a unit different from the signal generating source 1610.

The different unit is a data signal relay apparatus 1900, which has an input of an original data signal 1611 sent from a signal generating source 1610 on a certain transmission path 1901, and outputs an input data signal 151. The system configuration of FIG. 21 is identical to that shown in FIG. 18, except that the signal generating source 1610 is linked through the transmission path 1901.

Using the data signal relay apparatus 1900 of this embodiment enables the practice of data conversion service which converts a conventional data signal into the input data signal 151 which is fitted to the reduction of power consumption.

FIG. 22 shows a sixth embodiment of this invention which is designed to achieve the power consumption reduction of the data processing circuit 150 and the making of the process amount information 300 within a data processing unit 2000. The data processing unit 2000 includes a decoding process simulation unit 1620 and process amount calculation unit 1630 by which the process amount information 300 is computed. The process amount calculation unit 1630 has its output put in directly to the control circuit 100, and therefore the combiner 1650 of the preceding embodiments is not necessary. The environment information memory 1640 of the preceding embodiments has the same contents as the table 1000 in the control circuit, and therefore it is eliminated.

This embodiment enables the accomplishment of data processors (DVD playback unit, etc.) which deal with conventional data signals, and yet are capable of reducing the power consumption.

As described in the fourth, fifth and sixth embodiments, it is possible to apply the power consumption reducing schemes of this invention to a variety of systems.

According to this invention, it becomes possible to control the power supply voltage and clock frequency down to as low as their limits based on the process amount information which is more precise than the conventional scheme, whereby the reduction of power consumption of electronic circuits such as microcomputers can be effectuated more than the conventional counterparts. As a result, the problem of power consumption which has been a barrier of advancing the scale of integration of semiconductor integrated circuits is alleviated, and more large-scale and higher density semiconductor integrated circuits can be accomplished.

Industrial Applicability

The present invention is applicable generally to electronic circuits including semiconductor integrated circuits which are expected to progress in the reduction of power consumption, and it is particularly useful for video data processing systems having a huge volume of processing.

1. An electronic circuit of low power consumption comprising:
at least one of a power supply voltage control circuit which varies the power supply voltage in response to a voltage control signal or a clock frequency control circuit which varies the frequency of a clock signal in response to a frequency control signal;
a control circuit which produces at least one of the voltage control signal or the frequency control signal; and
a data processing circuit which processes an input data signal by being supplied with at least one of the power supply voltage from said power supply voltage control circuit or the clock signal from said clock frequency control circuit,
wherein
said control circuit comprises a circuit which produces the voltage control signal or the frequency control signal based on information of process amount which is correspondent to the input data signal and indicative of the amount of data processing executed by said data processing circuit.

2. The electronic circuit according to claim 1, wherein said information of process amount comprises information which indicates the number of clocks required for processing the input data signal by said data processing circuit.

3. The electronic circuit according to claim 1, wherein, after process method for processing the input data signal is divided into a plurality of process patterns depending on the process amount, said information of process amount comprises information which indicates the frequencies of occurrence of the process patterns in the input data signal.

4. The electronic circuit according to claim 3, wherein the input data signal comprises a video signal of picture, and said plurality of process patterns include at least a process pattern of a case where motion exists in a small part of the picture and a process pattern of a case where no motion exists in the small part of the picture.

5. The electronic circuit according to claim 3 having a table which stores numbers of clocks for processing in correspondence to the plurality of process patterns,
said control circuit producing at least one of the voltage control signal or the frequency control signal basing on a sequential operation comprising:
step 1 of initializing value C of the total number of clocks to 0;
step 2 of repeating the following step 3, while incrementing the process pattern number i from 1 to the total number of patterns;
step 3 of calculating the arithmetic product of the number of processing clocks K[i] required for the i-th process pattern, the frequency of occurrence P[i] of the i-th process pattern, and the total number of occurrences of all patterns, and adding the resulting product to the value C of the total number of clocks; and
step 4 of determining at least one of the power supply voltage or the clock frequency based on the resulting total value C of the numbers of clocks.

6. The electronic circuit according to claim 1, wherein said input data signal comprises a time-sequenced signal, with said information of process amount being inserted at corresponding positions of the time-sequenced signal.

7. The electronic circuit according to claim 1, wherein said information of process amount is supplied to said circuit over a path different from the path of the input data signal.

8. The electronic circuit according to claim 6 or claim 7, wherein said input data signal is supplied by an electronic recording medium storing said input data signal.

9. A method of reducing the power consumption in data processing, said method comprising the steps of:
decoding an encoded data signal;
evaluating process amount required for the decoding , and outputting a resulting information of process amount;
combining the information of information of process amount and the encoded data signal to produce an input data signal;
processing the input data signal by using the information of process amount; and
at least one of controlling the power supply voltage which is used for the processing of the input data signal or controlling the frequency of a clock signal which is used for the processing of the input data signal.

10. A method of reducing the power consumption in data processing, said method comprising the steps of:
decoding a data signal which is encoded in compliance with the MPEG (Motion Picture Coding Experts Group) standard;
evaluating process amount required for the decoding, and outputting a resulting information of process amount;
inserting the information of process amount to the extension part in the bit stream of the encoded data signal thereby to produce an input data signal;
processing the input data signal by using the information of process amount; and
at least one of controlling the power supply voltage which is used for the processing of the input data signal or controlling the frequency of a clock signal which is used for the processing of the input data signal.

11. The method according to claim 9 or claim 10, wherein in case there are a plurality of types of electronic circuits which process the input data signal by using the information of process amount and there are a plurality of kinds of operational environments of said electronic circuits, the information of process amount comprises a plurality of pieces of information of process amount, which correspond to the types of electronic circuits and the kinds of operational environments.
